(19) United States
(12) Patent Application Publication
(10) Pub. No.: US 2016/0092804 A1
(43) Pub. Date: Mar. 31, 2016

(54) APPARATUS FOR IMPROVING OPERATIONS OF INFORMATION PROCESSING SYSTEM, AND METHOD THEREFOR

(71) Applicant: HITACHI, LTD., Tokyo (JP)

(72) Inventor: Hiroaki SHIKANO, Tokyo (JP)

(73) Assignee: HITACHI, LTD., Tokyo (JP)

(21) Appl. No.: 14/785,717

(22) PCT Filed: Feb. 21, 2014
(86) PCT No.: PCT/JP2014/054198

§ 371 Date: Oct. 20, 2015

(51) Int. Cl. G06Q 10/06

(52) U.S. Cl. CPC G06Q 10/0633

(57) ABSTRACT

The present invention provides an apparatus for improving operations that improves operations management and enhances usability of an information processing system. The operations improvement apparatus improves the operations of an information processing system that includes a management-target device (146). The operations improvement apparatus includes computing apparatuses (100 and 110), and a storage apparatus (120) that is used by the computing apparatuses. The computing apparatus, in accordance with executing a prescribed computer program, acquires operational procedure information that includes a plurality of operational procedures of the information processing system, and analyzes the acquired operational procedure information (101). The computing apparatus extracts a procedure automation candidate, which is a candidate for a procedure that is capable of being automated, and outputs the extracted procedure automation candidate. A decision as to whether or not to automate can be made on the basis of the automatable procedure candidate.

### TECHNICAL FIELD

The present invention relates to an apparatus for improving operations of an information processing system, and a method therefor.

### BACKGROUND ART

Cloud computing, which makes use of an information processing system via a telecommunication network, has become widespread in recent years. Cloud computing is supported by an information processing system stored in a data center. The costs involved in managing the operations of an information processing systems at a data center are increasing annually, and these costs must be reduced.

In an information processing system, operations management is required for large numbers of servers and network equipment. Managing the operations of an information processing system, for example, includes confirming the operating status of each piece of equipment, rebooting the equipment, batch processing, disk backup processing, and dealing with cases in which abnormalities occur in the equipment. When managing these operations, an operator must also report the details and results of this management to clients. In addition, the operator not only performs the above-described management of information processing equipment, but also manages air conditioning facilities and power supplies, manages access to the data center, and monitors security. Making operations management more efficient is thus an important theme.

Accordingly, various approaches are being undertaken with the aim of reducing the costs of managing the operations of information processing systems. For example, there are efforts aimed at integrating the management of systems operations using operations management middleware, standardizing operations management processes using an Information Technology Infrastructure Library (ITIL), automating operational work procedures using Run Book Automation, and batch managing configuration information using a Configuration Management Database (CMDB). These tools and management methods save labor in the operational phase of equipment operation and equipment management.

The aforementioned operations management labor savings can be realized when constructing a new information processing system by introducing right from the start operational procedures that take into account standardization and automation. However, it is difficult to introduce the standardization and automation of operations management into an existing information processing system. This is because actual complicated operating procedures of the onsite operator must be identified in order to apply automation to the operational procedures of an existing information processing system. In order to identify the complicated operating procedures of the operator, operator operating time must be measured after having associated an operational procedure document with the operations of the operator. Therefore, considerable trouble is involved in advance preparations for introducing automation into operations management, and time and money are required to implement the automation of operations management.

In contrast to this, in Patent Literature 1, servers, storage, and so forth are monitored in line with implementing operational procedures that include work for modifying a resource configuration. In Patent Literature 1, resource usage that is equal to or greater than a fixed amount is classified as batch processing or the like for which automated execution is performed on a computer, and resource usage that is equal to or less than a fixed amount is classified as a procedures that is to be executed manually. Consequently, Patent Literature 1 identifies work procedures that should be automated.

### CITATION LIST

### Patent Literature

### [PTL 1]

WO 2013/111334

### SUMMARY OF INVENTION

### Technical Problem

In the prior art, when automating the operations management of an information processing system, the procedures to be automated must be identified beforehand. In order to identify automation-target procedures, it is necessary to glean the actual operating situation based on an operational procedure document, and as such, preparing for automation is time consuming and inconvenient.

With the foregoing problem in mind, an object of the present invention is to provide an apparatus and method of improving the operations of an information processing system, which are capable of improving the management of information processing system operations and enhancing usability.

### Solution to Problem

An apparatus for improving operations according to one aspect of the present invention is an operations improvement apparatus for improving the operation of an information processing system, and includes a computing apparatus and a storage apparatus that is used by the computing apparatus, wherein, by executing a prescribed computer program, the computing apparatus acquires operational procedure information that includes a plurality of operational procedures of the information processing system, and in accordance with analyzing the acquired operational procedure information, extracts a procedure automation candidate, which is a candidate for a procedure that is capable of being automated, and outputs the extracted procedure automation candidate.

### Advantageous Effects of Invention

According to the present invention, it is possible to extract and output a candidate for a procedure that is capable of being automated by analyzing operational procedure information. Therefore, the output result thereof can be put to good use in improving the operations of the information processing system.

### BRIEF DESCRIPTION OF DRAWINGS

FIG. 1 shows the overall configuration of an operations improvement support system.

FIG. 2 shows an example of a typical configuration of a server.

FIG. 3 shows a flowchart of processing for analyzing a procedure document.

FIG. 4 is a drawing illustrating the processing flow of a procedure automation analysis function.

FIG. 5 shows a flowchart of processing for managing an automated procedure component, which is a software component of an automatically executed procedure.

FIG. 6 shows a flowchart of processing for managing a manual procedure component that is executed manually.

FIG. 7 shows a flowchart of processing for creating an improved procedure document.

FIG. 8 shows a configuration of a procedure word dictionary database.

FIG. 9 shows a configuration of an operation-type database.

FIG. 10 shows a configuration of a database for managing a result of a procedure document analysis.

FIG. 11 shows a configuration of a database for managing a result of a procedure pattern analysis.

FIG. 12 shows a configuration of a database for managing a procedure pattern.

FIG. 13 shows a configuration of a database for defining an operation cost.

FIG. 14 shows a configuration of a database for managing a result of an operation cost analysis.

FIG. 15 shows a configuration of a database for managing a procedure component.

FIG. 16 shows a configuration of a database for managing an improved procedure document.

FIG. 17 shows an example of a screen for presenting a procedure automation candidate.

FIG. 18 shows an example of a screen for supporting the automation of an existing manual procedure.

FIG. 19 shows a screen for executing an automatic procedure based on a manual procedure.

### DESCRIPTION OF EMBODIMENTS

An embodiment of the present invention will be explained below while referring to the drawings. Furthermore, in the following explanation, various types of information may be explained using the expression “management table”, but the various information may also be expressed using a data structure other than a table. To show that the various information is not dependent on the data structure, “management table” can be called “management information”.

Further, there may be cases where processing is explained having a “program” as the subject. This program is executed by a processor, for example, a Central Processing Unit (CPU) to implement stipulated processing. Furthermore, since the processing is performed while using a storage resource (e.g., a memory) and a communication interface apparatus (e.g., a communication port) as needed, the processor may also be regarded as the subject. The processor may comprise dedicated hardware in addition to a CPU. A computer program may be installed in respective computers from a program source. The program source may be provided by, for example, either a program delivery host computer or a storage medium.

Each element is identifiable by a number, but if it is information that can be identified, other types of identification information, such as a name, may be used. In the drawings and descriptions of the present invention, the same reference signs are given to the same parts, but the present invention is not limited to the present embodiment, and all sorts of applications that correspond to the idea of the present invention are included in the technical scope of the present invention. Further, unless otherwise limited, all components may be either plural or singular.

In order to achieve the aforementioned object, the operations improvement apparatus comprises a cost definition table that associates a word representing an operational procedure of an information processing system with a cost of an operator operation. The operations improvement apparatus can calculate the operation cost of an operational procedure on the basis of a word representing this operational procedure by using the cost definition table. The greater the calculated operation cost of an operational procedure, the greater the effect of automating this operational procedure. Accordingly, the operations improvement apparatus presents the administrator of the information processing system with operational procedures in descending order of operation cost.

Consequently, according to the operations improvement apparatus related to the present embodiment, it is possible to extract and present to the administrator of the information processing system a candidate procedure capable of being automated by simply analyzing operational procedure information using the cost definition table.

### Example 1

### Overall Configuration

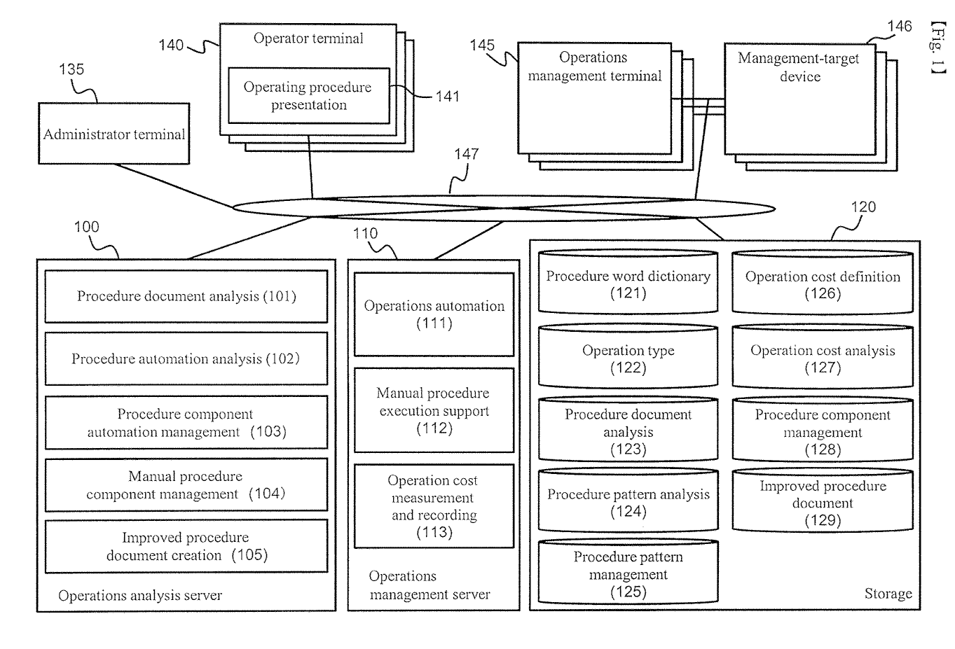

An example will be explained below. FIG. 1 shows an example of the overall configuration of a system that includes an operations improvement support system as an example of the “operations improvement apparatus”. The terms “function” and “database” may be omitted in the drawings. Database is abbreviated as DB.

The operations improvement support system, for example, can include an operations analysis server 100, an operations management server 110, and a storage 120. The operations analysis server 100, as will be described below, is a computer for analyzing an operational procedure document. The operations management server 110 is a computer for providing a function for operating a management-target device 146. The storage 120 is an apparatus for storing various types of information used in the analysis and so forth of the operational procedure document.

The operations analysis server 100 and the operations management server 110 are examples of the “computing apparatus”. The storage 120 is an example of the “storage apparatus”.

In FIG. 1, a plurality of management-target devices 146, an operations management terminal 145 for managing the operations of the management-target devices 146, an operator terminal 140 that is used by an operator, and an administrator terminal 135 that is used by a systems administrator are shown as an example of the “information processing system”.

The management-target device 146 is an apparatus that is the target of operations management, and, for example, is a server, a network switch, a storage system, and so forth. The operations management terminal 145 is used in an operation on a management-target server included among the management-target devices 146. In the following explanation, the reference sign 146 may be appended to a management-target server.

The operations analysis server 100, the operations management server 110, the storage 120, the administrator terminal 135, the operator terminal 140, the operations management terminal 145, and the management-target device 146 are connected in a manner that enables two-way communications via a communications network 147.

The overall configuration of the system is not limited to the example shown in FIG. 1. For example, the operations analysis server 100 and the operations management server 110 may be configured by linking a plurality of servers to each one, or the operations analysis server 100 and the operations management server 110 may be configured by being disposed inside a single physical server. The storage 120 may also be configured by linking a plurality of storages. For example, at the least any one of the DBs 121 to 129 of the storage 120 may be stored inside another storage.

In addition, the operations improvement support system related to the present example can also be configured as a so-called cloud service. In this case, the respective functions 101 to 105 of the operations analysis server 100 and the respective functions 111 to 113 and DBs 121 to 129 of the operations management server 110 are installed in a data center. Then, the administrator terminal 135 and the operator terminal 140, and the management-target device 146 and the operations management terminal 145 are connected to the data center via a communications network such as a Wide Area Network (WAN) or the like.

In accordance with being configured as a cloud service, the operations improvement support system can take charge of information processing systems at various sites deployed in various locations. As a result, the initial cost of investment and operational costs can be reduced compared to when an operations improvement support system is disposed at each site. In addition, since the operations improvement support system is able to glean information related to the operations of a plurality of information processing systems, it is possible to increase the accuracy of calculating the operation cost, which will be described below.

### <Overview of Functions Configuring Overall System>

In the operations improvement support system, the cost related to an operator operation is estimated by the operations analysis server 100 by analyzing an existing operational procedure document. Consequently, the operations improvement support system can present the administrator with a procedure that should be automated from the standpoint of the operation cost. Consequently, the operations improvement support system can support the automation of operational procedures, and propose the rearrangement of manual procedures.

The operations improvement support system, using the operations management server 110, provides a function 111 for automating operations, a function 112 for supporting the execution of a manual procedure, and a function 113 for measuring and recording an operation cost.

The operations automation function 111 provides a function for executing a previously prepared automated procedure on the management-target device 146. The manual procedure execution support function 112 provides a function for preparing and managing a procedure that the operator performs manually. The operation cost measurement and recording function 113 provides a function for recording the implementation time and the implementation result of an operation by the operator.

An operating procedure presentation function 141 is executed on the operator terminal 140, and presents the operator with an operational procedure document that is managed by the manual procedure execution support function 112. The operator operates the management-target device 146 via operations management terminal 145 in accordance with the presented operating procedure. Or, the operator operates the management-target device 146 via the operator terminal 140.

The respective functions of the operations analysis server 100 will be explained. An overview of each function will be explained here, and detailed descriptions will follow. A procedure document analysis function 101 reads an existing operational procedure document prepared, for example, using document preparation software and/or spreadsheet software, and extracts operation details from the operational procedure document in units of operating steps performed by the operator. The procedure document analysis function 101 analyzes the extracted operation details, and extracts units of repetitive operation details that are the same as a procedure pattern.

The procedure automation analysis function 102 classifies an operational procedure analyzed using the procedure document analysis function 101 as to whether it is a physical operation, or a Graphical User Interface (GUI)-based operation. The procedure automation analysis function 102 classifies the operating procedure thereof based on a word or expression that represents the operating procedure. For example, a physical operation such as replacing a storage medium cannot be automated. By contrast, a GUI operation is automatable.

The procedure automation analysis function 102 calculates an operation cost for an operating procedure that has been determined to be an automatable non-physical operation. The procedure automation analysis function 102, based on the word or expression that represents the operating procedure, computes the operation cost when the operator performs the operation manually in accordance with this procedure. The operation cost is computed taking into account the number of repetitions of a repeatedly implemented operating procedure within a set of operational procedure documents.

A procedure component automation management function 103, based on the automatability and operation cost determined by the procedure automation analysis function 102, presents the operations administrator with portions of operating procedures for which automation would be effective in descending order of operation costs. The operations administrator determines whether automation should be performed for the portions of the operating procedures that have been presented. The operations administrator may serve as an operator.

The procedure component automation management function 103 determines whether a similar automated procedure that has already been componentized (automated procedure component) exists for each portion of the operating procedures that have been determined as automatable. When the procedure component automation management function 103 has determined that a similar automated procedure component exists, the portion of the operating procedure may be replaced with this existing automated procedure component in accordance with a determination by the operations administrator.

The operations administrator can prepare a new automated procedure component even when an existing automated procedure component that is similar to a portion of an operating procedure determined to be automatable exists. In this case, the operations administrator uses the operations automation function 111 of the operations management server 110 to automate the portion of the operating procedure that is capable of being automated.

A manual procedure component management function 104 manages a manual procedure component, which is a componentized operating procedure executed manually by the operator. The manual procedure component management function 104 determines whether a similar existing manual procedure component exists for a portion of an operating procedure that was not determined to be automatable by the procedure component automation management function 103, or for a portion of an operating procedure that the operations administrator decided not to automate. A portion of an operating procedure that was either not determined to be automatable, or that the operations administrator decided not to automate will be called a target portion here.

When the manual procedure component management function 104 has determined that a portion of an operating procedure similar to an existing manual procedure component exists, the target portion is replaced with the existing manual procedure component in accordance with a determination by the operations administrator. When it has either been determined that a portion of an operating procedure similar to an existing manual procedure component does not exist, or the operations administrator has decided to make a new component, the manual procedure execution support function 112 of the operations management server 110 prepares a manual procedure component that corresponds to the target portion.

An improved procedure document creation function 105 creates a procedure document after an automated procedure component and/or a manual procedure component has been introduced. To make use of an automated procedure component, the improved procedure document creation function 105 creates a procedure document by adding a manual procedure for starting up the automated procedure component.

The operations management server 110 provides the following various types of functions. The operations automation function 111 provides various means for automating operational procedures. The operations automation function 111 normally uses a flowchart to represent operating procedures to be automated, and sets various setting values and expected values regarding results obtained at operating procedure execution. The operations automation function 111 also defines a procedure to deal with a case where an execution result does not match the expected value.

In order to automatically execute an operation, a script and batch file are defined and an Application Programming Interface (API) is invoked for each operating procedure. The API provides middleware and an application that are the targets of the operation.

The operations automation function 111 also provides a function for executing an automated operating procedure as an automated procedure component at a prescribed timing on a management-target device 146. The prescribed timing, for example, is either when a predetermined date/time condition has been reached, or when an operator has performed a start operation.

The operations automation function 111 has a function for confirming an execution result, and notifying the operations administrator to the effect that the execution result of an automated procedure does not match the expected result.

The manual procedure execution support function 112 prepares an operational procedure for the operator to execute an operating procedure manually. In addition, the manual procedure execution support function 112 provides various means for supporting the execution of a procedure performed manually by the operator.

As the various means, for example, there is management of the preparation and revision of an operational procedure document by representing an operating procedure with a flowchart, management of an operational item for a management-target device 146, allocation of the operational item to the operator, confirmation of an operational result, or management of the operator's work shift.

The manual procedure execution support function 112 specifies to the operator via the operator terminal 140 an operational item to be implemented by the operator, and, in addition, delivers an operational procedure document to the operator terminal 140.

The procedure presentation function 141 of the operator terminal 140 implements display, in procedure step units, of an operating procedure for the operator in charge of operations. The operating procedure presentation function 141 seeks to confirm for the operator whether the result of the information processing system operation (procedure execution result) matches the expected value at each step. In so doing, the operating procedure presentation function 141 supports an operation by the operator, and enhances the reliability of the operation.

The operation cost measurement and recording function 113 coordinates with the operations automation function 111 and the manual procedure execution support function 112 to record the execution time of an automated procedure and the implementation time of a manual procedure performed by the operator. The operation cost measurement and recording function 113 can be put to practical use in the computation of the operation cost utilized in accordance with the procedure automation analysis function 102 of the operations analysis server 100.

### <Example of Server Configuration>

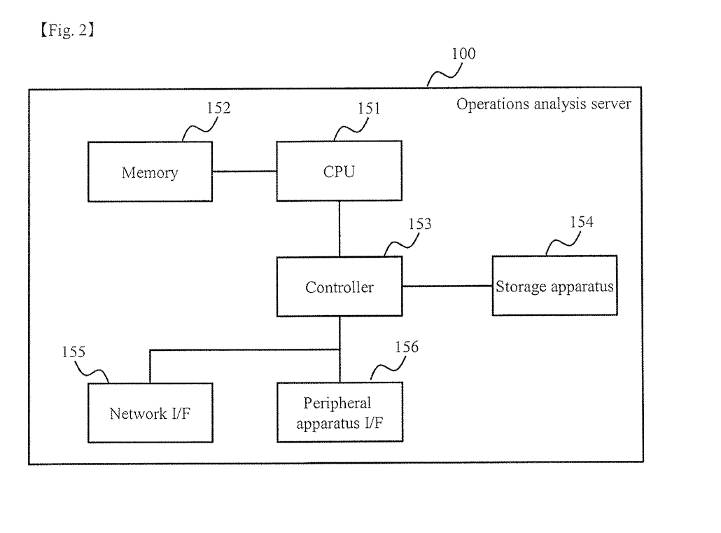

FIG. 2 shows an example of the configuration of the operations analysis server 100 and the operations management server 110. The servers comprise a central processing unit (CPU) 151 that executes a computing process, a memory 152 that temporarily stores a program and data, a controller 153 that controls various interfaces, a storage apparatus 154 for storing various data and programs, a network interface 155, and a peripheral apparatus interface 156.

The network interface 155 connects to other apparatuses via the communications network 147. The peripheral apparatus interface 156 connects to a peripheral apparatus, such as a display apparatus and/or a keyboard apparatus. In addition to the aforementioned, the peripheral apparatuses can include information input and output apparatuses, such as, for example, a printer, a synthesized speech output apparatus, a touch panel, and a speech input apparatus.

The respective functions 101 to 105 and 111 to 113 of the servers 100 and 110 are realized by the CPU 151 executing a prescribed computer program stored in either the memory 152 or the storage apparatus 154. The prescribed computer program realizes a prescribed function by making suitable use of already prepared programs such as an operating system (OS), a device driver, and various libraries, for example. The configuration may be such that a prescribed computer program is provide for each function, or the configuration may be such that one prescribed computer program realizes a plurality of functions. The prescribed computer program can be distributed by being affixed on a storage medium, or by being transmitted over a communications network.

The configuration of the operations analysis server 100 and the operations management server 110 is not limited to the example shown in FIG. 2. As described above, the configuration may also be such that a plurality of computers are linked together, and the plurality of computers collectively realize the functions as the operations analysis server 100 and the operations management server 110. Or, the configuration may be such that a terminal connected to the information input apparatus and the information output apparatus is disposed separately, and the servers 100 and 110 input and output information via the terminal. The configuration may also be such that the operations analysis server 100 and the operations management server 110 are physically disposed inside a single computer. The operations analysis server 100 and the operations management server 110 need not be disposed at the same site, but rather may be installed separately at different sites.

### <Procedure Document Analysis Function>

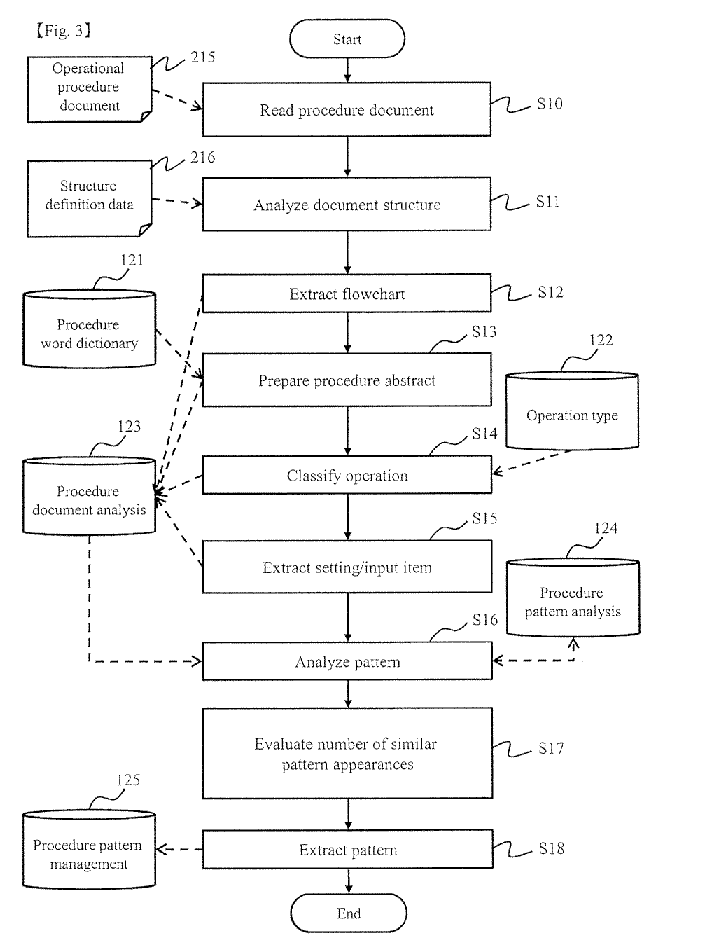

The processing of the procedure document analysis function 101 will be explained using the flowchart of FIG. 3. First of all, the procedure document analysis function 101 reads an existing operational procedure document 215 for a management-target device 146 (S10).

The operational procedure document 215 is most often prepared electronically using either document preparation software (word processor) or spreadsheet software, and therefore in Step S10 it is assumed that an operational procedure document 215 in a digital file format will be read. In the case of an operational procedure document that is not digitized, for example, digitization is performed using Optical Character Recognition (OCR) technology.

The procedure document analysis function 101 reads structure definition data 216, uses the structure definition data 216 to analyze a document structure of the operational procedure document 215, and extracts a character string corresponding to an operating procedure from within the operational procedure document 215 (S11). The structure definition data 216 is data that specifies in advance the structural position in the operational procedure document 215 of the character string corresponding to the operating procedure.

For example, when the operational procedure document 215 is prepared using document preparation software, the procedure document analysis function 101 uses header information such as chapters and paragraphs, and structural information such as itemized points to extract a character string that corresponds to the operating procedure.

For example, when the operational procedure document 215 is prepared using spreadsheet software, the procedure document analysis function 101 uses structural information such as position of a cell row and ruled line enclosures to extract a character string that corresponds to the operating procedure.

For example, when the operational procedure document 215 is printed matter, a character string that corresponds to the operating procedure is extracted on the basis of positional information such as indentation, or on the basis of a location marked beforehand by the operations administrator.

The procedure document analysis function 101 extracts a flow based on the character string corresponding to the operating procedure extracted in Step S11 (S12). The flow extracted in Step S12 defines the order relationship of character strings that correspond to the operating procedure in terms of their order of appearance in the operational procedure document 215.

The operational procedure document 215 may also include a “branch” that determines the next operating procedure in accordance with an implementation result. In this case, the procedure document analysis function 101 detects the presence or absence of a branch and the branch destination based on a character string that corresponds to the branch.

The procedure document analysis function 101 records the relationship between the character string corresponding to the operating procedure and the order thereof extracted as the flow in a procedure document analysis DB 123.

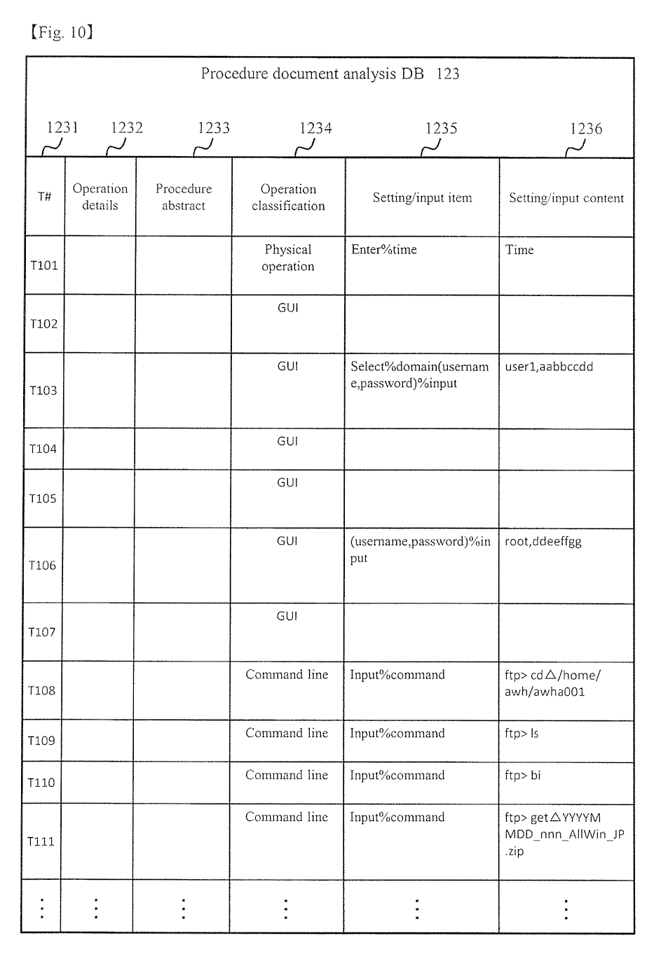

An example of the procedure document analysis DB 123 is shown in FIG. 10. The DB 123, which manages the results of procedure document analysis, manages a procedure number 1231, operation details 1232, a procedure abstract 1233, a setting/input item 1235, and setting/input content 1236.

The procedure number 1231 is a number assigned to each operating procedure. In the drawing, the procedure number is abbreviated as “T#”. The operation details 1232 is a character string of the extracted operating procedure. The procedure abstract 1233 is an abstract extracted from the operating procedure stored in the operation details 1232. The setting/input item 1235 is an item that is set and/or inputted by the operator. The setting/input content 1236 is content that is either set or input by the operator.

Examples of the operation details 1232 and procedure abstract 1233 will be described below.

### (1) Procedure Number: T101

(1A) Operation Details: Confirm operation target, and enter work implementation time in Attachment: “List of Server Terminals Targeted for Virus Software Update”.
(1B) Procedure Abstract: Operation target, confirmation, update, server, terminal, time, enter

### (2) Procedure Number: T102

(2A) Operation Details: Double-click on server “SRV1” remote desktop shortcut and execute.
(2B) Procedure Abstract: Server, remote desktop, shortcut, double-click, execute

### (3) Procedure Number: T103

(3A) Operation Details: Select the domain “grp” on login screen, input username “user1” and password “aabbccdd”, and press login button.
(3B) Procedure Abstract: Login, screen, domain, select, username, password, input, login, button, press

### (4) Procedure Number: T104

(4A) Operation Details: Double-click on “anti-virus update” folder on desktop to open.
(4B) Procedure Abstract: Desktop, update, folder, double-click, open

### (5) Procedure Number: T105

(5A) Operation Details: Double-click on “shortcut to anti-virus FTP (operations management #2).bat” in same folder and execute.
(5B) Procedure Abstract: Folder, FTP, shortcut, double-click, execute

### (6) Procedure Number: T106

(6A) Operation Details: Since user ID/password open, input username “root” and password “ddeeffgg”, and press login button.
(6B) Procedure Abstract: User ID, password, username, password, input, login, button, press

### (7) Procedure Number: T107

(7A) Operation Details: Confirm that command prompt for input waiting state opens and that following log is outputted.
(7B) Procedure Abstract: Command prompt, open, log, output, confirm

### (8) Procedure Number: T108

(8A) Operation Details: Input following command and move directory. ftp>cd/home/awh/awha001
(8B) Procedure Abstract: Command, input, directory, move

### (9) Procedure Number: T109

(9A) Operation Details: Input following command and confirm batch file. ftp>1 s
(9B) Procedure Abstract: Command, input, batch file, confirm

### (10) Procedure Number: T110

(10A) Operation Details: Input following command, and transition to binary mode. ftp>bi
(10B) Procedure Abstract: Command, input, binary mode

### (11) Procedure Number: T111

(11A) Operation Details: Input following command, and transfer batch file to local PC. ftp>get YYYYMMDD_nnn_AllWin_JP.zip
(11B) Procedure Abstract: Command, execute, batch file, local, PC, transfer

Return to FIG. 3. The procedure document analysis function 101 prepares the procedure abstract 1233 by reading a procedure word dictionary DB 121, and comparing the extracted operating procedure character string to words registered in the procedure word dictionary DB 121 (S13). Step S13 is a process for detecting the number of times an operating procedure has been repeatedly executed by comparing procedure abstracts. That is, in the present example, a procedure abstract is prepared as a pre-classification for efficiently retrieving operating procedures having similar details from among a plurality of operating procedures.

The procedure word dictionary DB 121 is a DB that defines beforehand words related to operation details for an information processing system. The procedure document analysis function 101 prepares a procedure abstract 1233 by outputting these words in a case where the words defined in the procedure word dictionary DB 121 match up with a character string stored in the operation details 1232.

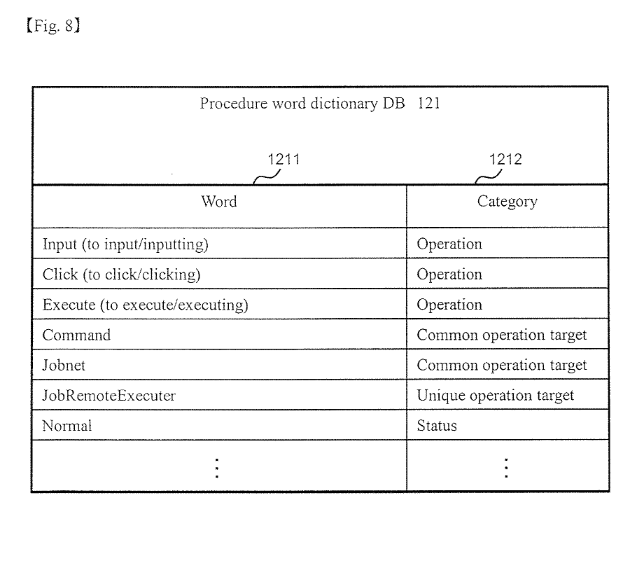

FIG. 8 shows an example of the procedure word dictionary DB 121. A word 1211 is a term used in an operating procedure. A category 1212 is the category of a term stored under word 1211. The category 1212 includes, for example, “operation target”, “operation”, “status” and so forth.

Under category 1212, “operation target” may represent a piece of software that performs an operation, various functions in a piece of software, a GUI component such as a window or a button, and other such operation targets, for example. Under category 1212, “common operation target” is set for common operation targets regardless of the application or OS. In contrast thereto, “unique operation target” is set for a unique operation target. Under category 1212, “operation” corresponds to an operator operation for an operation target, and, for example, words like “input” and/or “click” are categorized as an “operation”.

Furthermore, the procedure word dictionary DB 121 defines the standard form of words used in the operating procedure, as well as their conjugated forms, synonyms, and similar terms.

Return to FIG. 3. The procedure abstract created in Step S13 is recorded in the procedure abstract 1233 of the procedure document analysis DB 123 shown in FIG. 10.

The procedure document analysis function 101 classifies the operation of each operating procedure in accordance with a predefined operation-type DB 122 (S14). The classification of an operation is for determining the type of each operating procedure, and the types may include a physical apparatus operation, a GUI-based operation, an operation using a command, batch or other such command line, and a communication via telephone or email. The classification result in Step S14 is used when determining the possibility of automating a procedure.

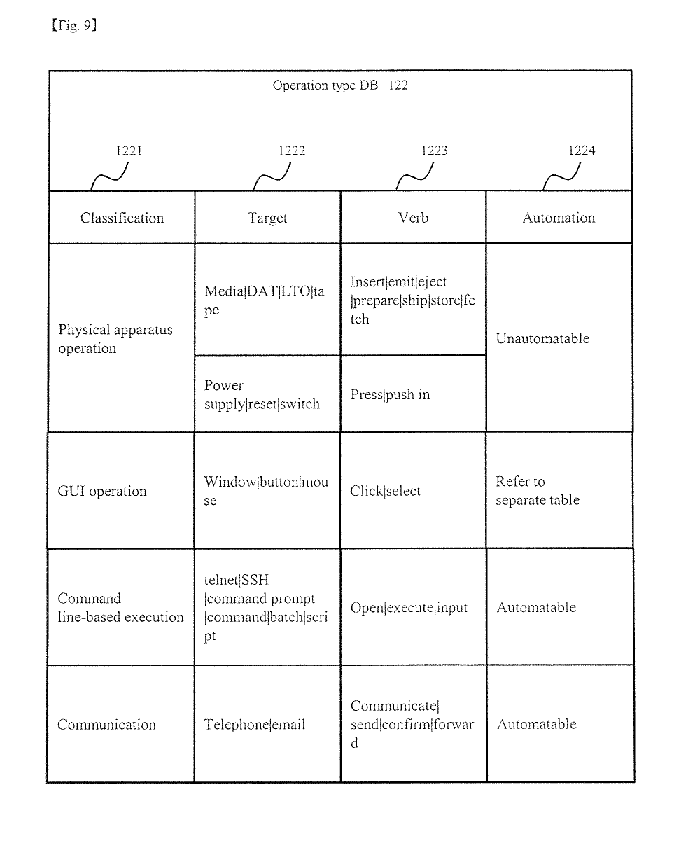

FIG. 9 shows an example of the configuration of the operation type DB 122. The operation type DB 122, for example, manages a classification 1221, a target 1222, a verb 1223, and an automation 1224.

The classification 1221 is the classification of an operation. The target 1222 is the operation target corresponding to the classification 1221. As operation targets there are, for example, “medium”, “Digital Audio Tape (DAT)”, “Linear Tape-Open (LTO)”, “power supply”, “reset”, “switch”, “window”, “command”, “script”, “telephone” and “email”. The verb 1223 represents the action of an operation, such as, for example, “insert”, “press”, and “select”. In other words, the operation type DB 122 stipulates the classification 1221 of an operation using a combination of the operation target 1222 and the operation details 1223.

The automation 1224 defines the possibility of automation for an operation classification 1221. For example, a physical apparatus operation, such as mounting a tape on a tape backup apparatus, requires an actual manual operation by an operator, and therefore is set as “unautomatable” under automation 1224.

For a GUI-based operation, the advisability of automation is decided in accordance with the target of a GUI operation, such as an application or middleware. A GUI operation can be determined to be automatable only when an application or middleware, which is the operation target, is operable using a batch file, an API or the like corresponding to the GUI operation. The possibility of being able to automate a certain GUI operation depends on the type of application or middleware being targeted by the GUI operation. Thus, a separate table that defines automatability by GUI operation target is used.

The execution of a command line operation and/or a telephonic or email communication can be defined as automatable.

Return to FIG. 3. The procedure document analysis function 101 sets the “operation classification” created in Step S14 under an operation classification 1234 of the procedure document analysis DB 123 shown in FIG. 10.

The procedure document analysis function 101 extracts a setting/input item from the character string corresponding to each operating procedure (S15). The setting/input item is an item set and input by the operator from a keyboard or the like when executing a function of an application, middleware, or an OS.

For example, the “username” or “password” that the operator is required to input in a login process is one setting/input item. In Step S15, an item required for either a setting or an input is automatically extracted by analyzing a character string. For example, in the case of a phrase such as “set ˜”, the word located immediately after “set” is extracted as the setting/input item.

In the operational procedure document 215, the setting/input item is most often displayed in an emphatic manner so as to stand out. For example, the setting/input item is often defined on a separate line by starting a new line, or by being enclosed in either brackets or quotation marks. Accordingly, the setting/input item can be extracted by focusing on a highlighted display like this when analyzing the character string.

The procedure document analysis function 101 sets the setting/input item and contents thereof extracted in Step S15 under a setting/input item 1235 and a setting/input contents 1236, respectively, of the procedure document analysis DB 123 shown in FIG. 10.

The procedure document analysis function 101 utilizes the procedure abstract prepared in Step S13 to perform pattern analysis for extracting a repetitive portion of an operating procedure (S16). In the pattern analysis, repetitive elements of operating procedures are analyzed with the aim of extracting an operating procedure as a set of a fixed number or more of meaningful operation details.

Generally speaking, in the operational procedure document 215 of an information processing system, rather than using each of the respective functions of an application, middleware, or an OS in a uniform manner, most often a specific function is executed repeatedly. In addition, when automating operating procedures, it is more effective to automate an operating procedure that is implemented repeatedly.

Accordingly, the procedure document analysis function 101 reads an extracted procedure abstract 1233 recorded in the procedure document analysis DB 123 shown in FIG. 10, and commences a pattern analysis.

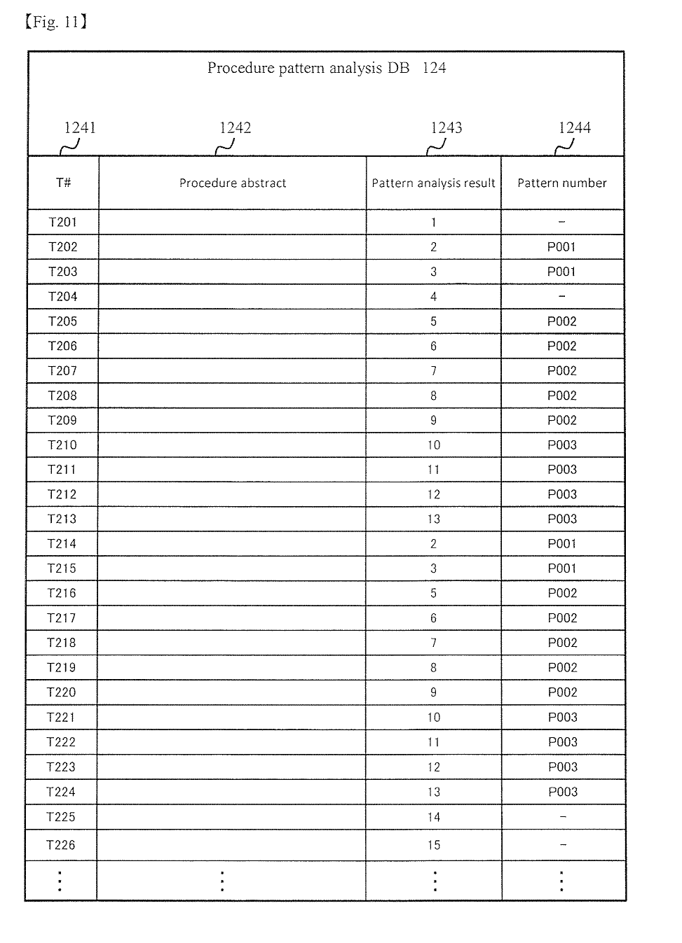

FIG. 11 shows a procedure pattern analysis DB 124 showing the results midway through the pattern analysis process of Step S16. The pattern analysis DB 124 associatively manages a procedure number 1241, a procedure abstract 1242, a pattern analysis result 1243, and a pattern number 1244.

The pattern analysis result 1243 is a tentative identification result, and when this result matches the procedure abstract, the same number as the procedure abstract is set, and when it differs, a different number is set. The pattern number 1244 is a number for identifying a pattern that is ultimately extracted. In a case where the details of a plurality of procedures are substantially the same even though the values of the pattern analysis results 1243 thereof differ, the same pattern number is set.

Examples of the procedure abstracts 1242 in the procedure pattern analysis DB 124 will be described below.

### (1) Procedure Number: T201

(1A) Procedure Abstract: File, DAT, tape, ship, tape, shipment,

### (2) Procedure Number: T202

(2A) Procedure Abstract: DAT, tape, confirmation,

### (3) Procedure Number: T203

(3A) Procedure Abstract: Management, DAT, tape, insert,

### (4) Procedure Number: T204

(4A) Procedure Abstract: End, check, work, end, confirm,

### (5) Procedure Number: T205

(5A) Procedure Abstract: Jobnet, select,

### (6) Procedure Number: T206

(6A) Procedure Abstract: Menu, execution and registration, select,

### (7) Procedure Number: T207

(7A) Procedure Abstract: Execution and registration, perform,

### (8) Procedure Number: T208

(8A) Procedure Abstract: Execution and registration, button, press,

### (9) Procedure Number: T209

(9A) Procedure Abstract: Jobnet, normal, end, confirm,

### (10) Procedure Number: T210

(10A) Procedure Abstract: Management, DAT, button, tape, remove,

### (11) Procedure Number: T211

(11A) Procedure Abstract: Management, DAT, tape, insert,

### (12) Procedure Number: T212

(12A) Procedure Abstract: Tape, remove,

### (13) Procedure Number: T213

(13A) Procedure Abstract: Tape, check,

### (14) Procedure Number: T214

(14A) Procedure Abstract: DAT, tape, confirmation,

### (15) Procedure Number: T215

(15A) Procedure Abstract: DAT, tape, management, insert,

### (16) Procedure Number: T216

(16A) Procedure Abstract: Jobnet, select,

### (17) Procedure Number: T217

(17A) Procedure Abstract: Menu, execution and registration, select,

### (18) Procedure Number: T218

(18A) Procedure Abstract: Execution and registration, perform,

### (19) Procedure Number: T219

(19A) Procedure Abstract: Execution and registration, button, press,

### (20) Procedure Number: T220

(20A) Procedure Abstract: Jobnet, normal, end, confirm,

### (21) Procedure Number: T221

(21A) Procedure Abstract: Management, DAT, button, tape, remove,

### (22) Procedure Number: T222

(22A) Procedure Abstract: Management, DAT, tape, insert,

### (23) Procedure Number: T223

(23A) Procedure Abstract: Tape, remove,

### (24) Procedure Number: T224

(24A) Procedure Abstract: Tape, check,

Return to FIG. 3. The procedure document analysis function 101 in Step S16 extracts a repetitive procedure by analyzing the pattern analysis result 1243. For example, Dynamic Programming (DP) matching can be used as the algorithm for extracting a pattern. The procedure document analysis function 101 assigns a unique pattern number 1244 to the extracted repetitive procedure.

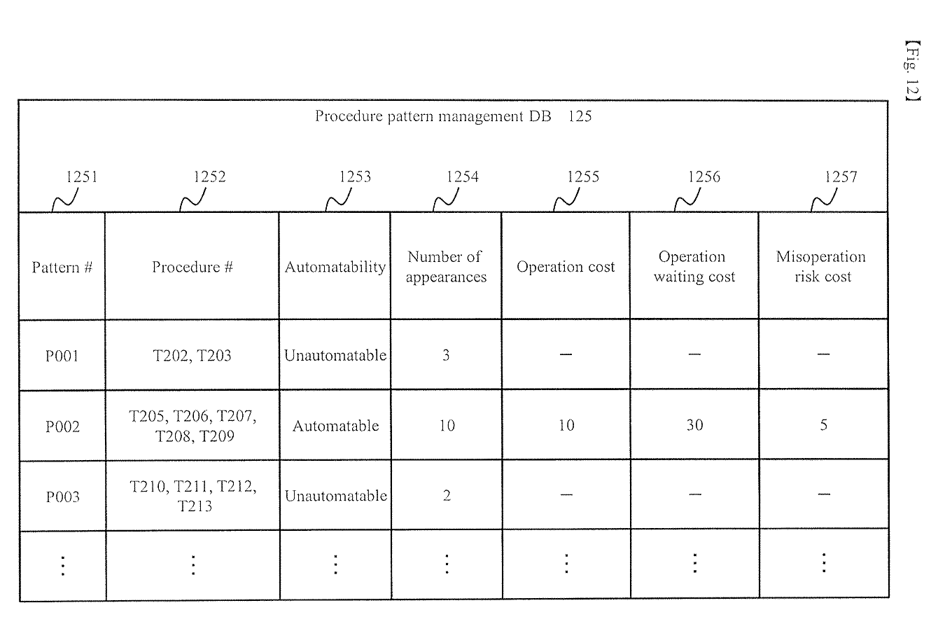

The procedure document analysis function 101 evaluates the number of repetitions for the extracted procedure pattern (S17), and registers a procedure pattern having a fixed number or more of repetitions (e.g., 2 or more) in a procedure pattern management DB 125 shown in FIG. 12 (S18).

FIG. 12 is an example of the configuration of the procedure pattern management DB 125. The procedure pattern management DB 125 associatively manages a pattern number 1251, a procedure number 1252, an automatability 1253, a number of appearances 1253, an operation cost 1255, an operation waiting cost 1256, and a misoperation risk cost 1257.

The pattern number 1251 is a number that identifies a pattern. The procedure number 1252 is a number that identifies a series of procedures included in a pattern identified by the pattern number 1251. The automatability 1253 shows the possibility of a series of procedures included in a pattern identified by the pattern number 1251 being able to be automated. The operation cost 1255 shows the cost when the series of procedures included in a pattern are operated manually by the operator. The operation waiting cost 1256 is the cost related to waiting for the result of an operation. The misoperation risk cost 1257 is the cost related to an erroneous operation by the operator.

As a result of having executed Step S18 of FIG. 3, the procedure document analysis function 101 sets the pattern number created in Step S16 in the procedure pattern management DB 125 as the pattern number 1251, sets the number of the operating procedures comprising the respective procedure patterns (corresponding to the procedure number 1231 of the procedure document analysis DB 123) in the procedure pattern management DB 125 as the procedure number 1252, and sets the number of appearances (number of repetitions) of the procedure pattern obtained in Step S17 in the procedure pattern management DB 125 as the number of appearances 1254.

### <Procedure Automation Analysis Function>

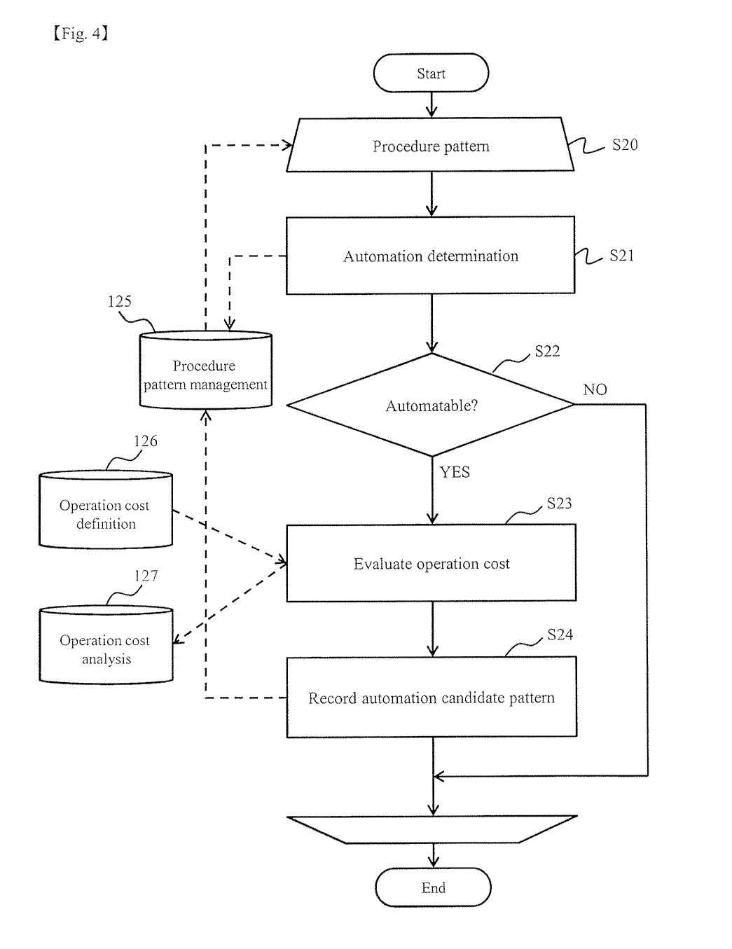

The processing of the procedure automation analysis function 102 will be explained using the flowchart of FIG. 4. The procedure automation analysis function 102 reads the procedure pattern registered in the procedure pattern management DB 125 (S20), and executes the following processes S21 to S24 for each procedure pattern.

First, the procedure automation analysis function 102 determines whether the respective procedure patterns are automatable (S21). The procedure automation analysis function 102 determines automatability using the operation classification created by the procedure document analysis function 101 in Step S14 of FIG. 3. That is, the procedure automation analysis function 102 determines as unautomatable a procedure pattern that includes in the operating procedures comprising the procedure patterns operation details that have been determined to be unautomatable. The procedure automation analysis function 102 makes a determination of automatable in a case where it has been determined that all the operation details comprising the operating procedures are automatable. The result of the automatability determination in Step S21 is recorded under automatability 1253 of the procedure pattern management DB 125 shown in FIG. 12.

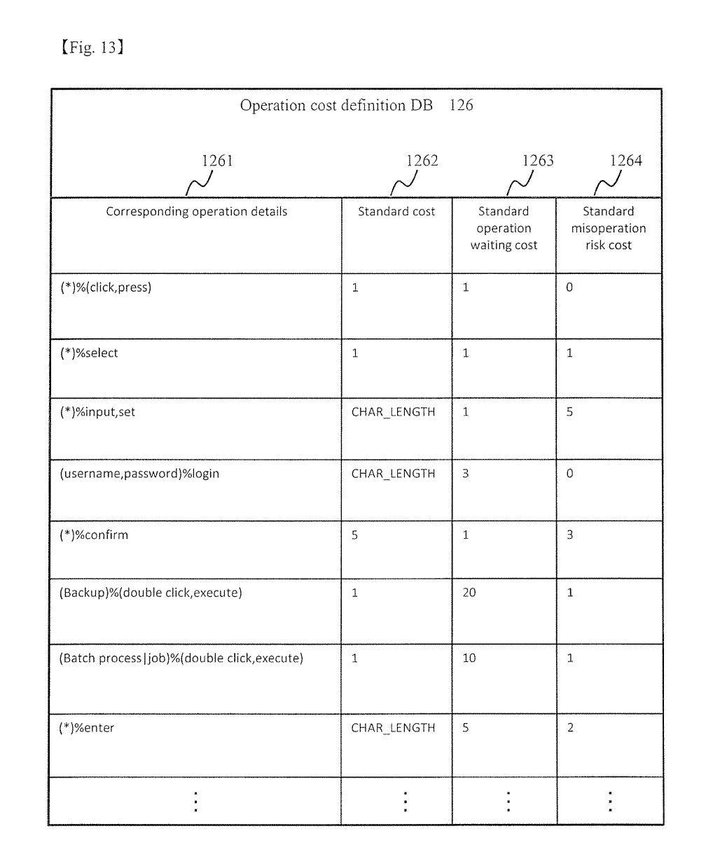

The procedure automation analysis function 102 ends the present processing when it has been determined that the result of Step S21 is unautomatable (S22: NO). When a determination of automatable is made (S22: YES), the procedure automation analysis function 102 evaluates the operation cost (S23). The operation cost evaluation is performed by referring to operation costs that have been preset in the operation cost definition DB 126 in accordance with an operation target and operation details. FIG. 13 shows an example of the configuration of the operation cost definition DB 126.

The operation cost definition DB 126 manages a corresponding operation details 1261, a standard cost 1262, a standard operation waiting cost 1263, and a standard misoperation risk cost 1264.

The corresponding operation details 1261 defines a combination of an operation target and operation details. In the present example, this combination is defined as “(operation target) % (operation details)”. An asterisk “*” represents an arbitrary target, a comma inside parentheses “,” represents an AND condition, and bar “|” represents an OR condition.

For example, the corresponding operation details of the first row of the operation cost definition DB 126 signifies that either clicking or pressing is performed for an arbitrary operation target.

In the present example, an operation cost is set for a combination of an operation target and operation details (corresponding operation details 1261). In the present example, three types of costs, i.e., 1262, 1263, and 1264, are taken into account as operation costs.

The standard cost 1262 is a cost representing the effort (or time) related to a manual operation by the operator. The standard operation waiting cost 1263 is a cost representing a system operation waiting time for obtaining the result of a manual operation by the operator. The standard misoperation risk cost 1264 is a cost based on the probability of an operational error on the part of the operator.

A larger standard cost 1262 signifies that a more complicated operation is required by the operator. For example, the larger the number of clicks using a mouse, and the larger the number of items that are set and inputted from a keyboard, the larger the standard cost becomes. The standard cost 1262 may be defined as the amount of effort put into an operation (number of clicks, number of setting items, and so forth), may be defined as the standard time required for an operation, or may be defined on the basis of another evaluation perspective.

The standard operation waiting cost 1263 represents the time that the operator spends waiting to obtain an operation result due to the long time it takes for processing by an information processing system. The standard operation waiting cost 1263 depends on the operation target and function, the specifications of the information processing system, and information processing system conditions. The operation target and function, for example, are the application and/or middleware, and the various functions thereof. The specifications of the information processing system, for example, are CPU speed, memory capacity, and so forth. The information processing system conditions, for example, are things like the size of a target file in a backup process, memory usage, and CPU utilization.

For example, a time that serves as a criteria is obtained from a past operations result and set in the standard operation waiting cost 1263. When the operation cost measurement and recording function 113 on the operations management server 110 manages a wait time results value, this results value may be set in the standard operation waiting cost 1263. For example, a system operation time for each operating procedure, a time required for the operator to perform an operational procedure, and so forth may serve as the results value.

The standard misoperation risk cost 1264 is for setting the likelihood of the operator making a human error as a cost. For example, in an operation for setting and inputting characters and numerals from a keyboard, operational errors such a typographical error occur at a fixed level of probability. Automating operational procedures has the effect of preventing human errors. Accordingly, in the present example, an operation cost that corresponds to the probability of an operational error occurring is set. The frequency of occurrence of operational errors by the operator may be calculated based on the operations results of the management-target device 146, and the calculated value may be set as the standard misoperation risk cost 1264.

Furthermore, the respective costs 1262 to 1264 are set using predefined fixed units. For example, a mouse click in a GUI operation may be defined as one cost unit, and a menu selection may be defined as one cost unit. Or, each cost may be managed as a unit of time.

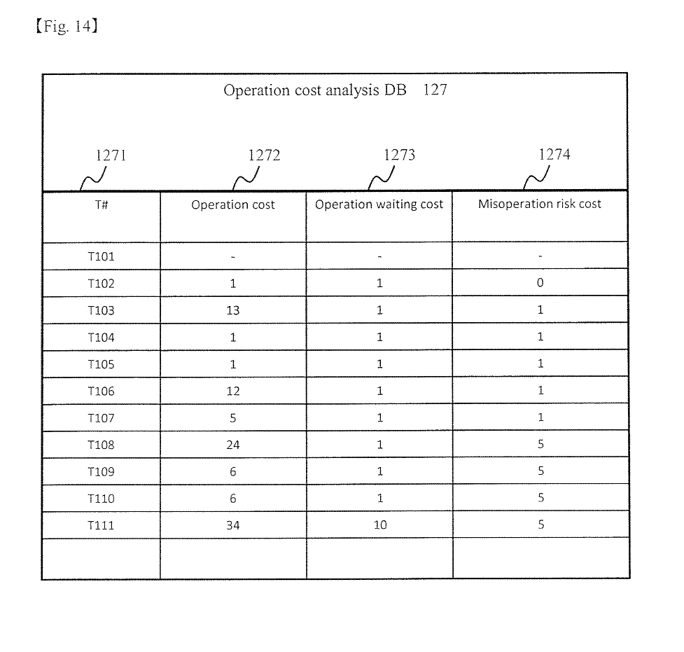

The weight placed on each of the costs 1262 to 1264 may be changed in accordance with the operating conditions of the information processing system. This is because the time required for a manual operation and the rate of occurrence of operational errors change in accordance with the proficiency of the operator. The procedure automation analysis function 102 records, for each procedure number 1271 in respective columns 1272 to 1274 of an operation cost analysis DB 127 shown in FIG. 14, various costs computed for each operating procedure using the operation cost definition DB 126.

The procedure automation analysis function 102, based on the various costs 1272 to 1274 for each operating procedure, calculates the sum of the operation costs of each operating procedure comprising a procedure pattern, and stores these sums as the operation cost 1255, the operation waiting cost 1256, and the misoperation risk cost 1257 in the procedure pattern management DB 125 (S24).

### <Procedure Component Automation Management Function>

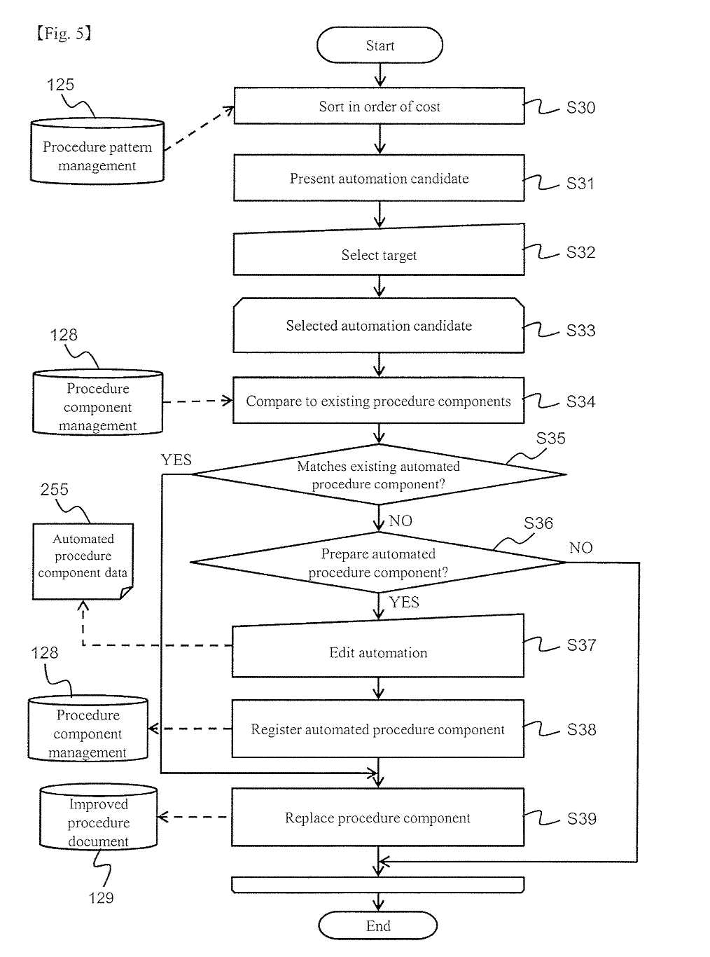

The processing of the procedure component automation management function 103 will be explained using FIG. 5. The procedure component automation management function 103 extracts an automatable procedure pattern from the procedure pattern management DB 125, computes the total of the various costs 1255 to 1257 for each extracted automatable procedure pattern, and sorts the total values in descending order (S30).

The procedure component automation management function 103 presents the operations administrator, who is the user of the present system, with candidates for automatable operating procedures in descending order of operation costs (S31).

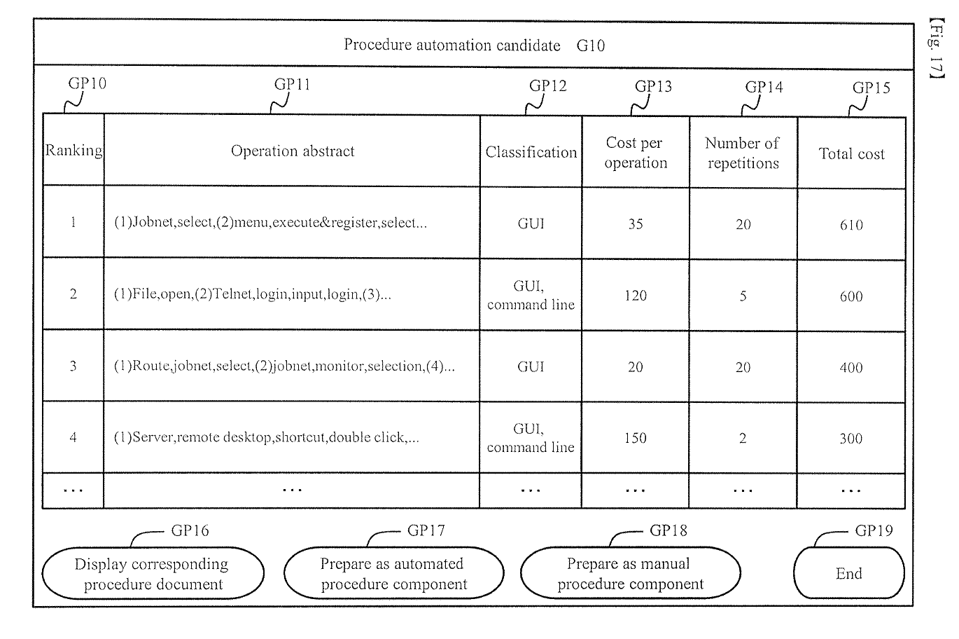

FIG. 17 shows an example of a screen G10 for presenting a candidate for an operating procedure that should be automated. The screen G10, which presents a candidate for an automatable procedure, associatively displays a ranking GP10, an operation abstract GP11, a classification GP12, a cost per operation GP13, a number of repetitions GP14, and a total cost GP15, for example.

The ranking GP10 shows the descending order for the total cost GP15, and indicates that the smaller the ranking GP10 numeral, the greater the effect of automation. The operation abstract GP11 shows an abstract of the operation details of a candidate for an automatable operating procedure (procedure pattern). The candidate for an automatable operating procedure is set as a combination of several procedures.

The classification GP12 shows the type to which an automatable operating procedure candidate belongs. The cost GP13 is the cost required each time an automatable operating procedure candidate is executed. The cost per operation GP13 is the total of the costs of the respective procedures included in the procedure pattern nominated as a candidate. Then, the cost of each procedure is the total of the operation cost, the operation waiting cost, and the misoperation risk cost.

The number of repetitions GP14 is the number of times that an automatable operating procedure candidate is repeated. The total cost GP15 is a value obtained by multiplying the cost per operation GP13 and the number of repetitions GP14 for an automatable operating procedure candidate.

Various buttons GP16, GP17, GP18 and GP19 are arranged beneath the screen G10. The button GP16 is a button for displaying on the screen a portion of the operational procedure document 215 targeted for analysis that corresponds to a candidate for an automatable operating procedure. The operations administrator can confirm a description in the operational procedure document 215 by pressing the button GP16.

The button GP17 is a button for instructing the preparation of an automated procedure component. When the operations administrator presses the button GP17 after having selected an automatable operating procedure candidate, a component for automatically executing the selected operating procedure is created. The button GP18 is a button for instructing the preparation of a manual procedure component.

Return to FIG. 5. The operations administrator selects an automation target from among the operating procedure candidates presented on the screen G10. The procedure component automation management function 103 receives the result of the selection by the operations administrator (S32).

The procedure component automation management function 103 performs the following steps S34 to S39 for each operating procedure (procedure pattern) selected as an automation candidate (S33). An operating procedure targeted for processing from among the selected operating procedures may be abbreviated as process-target automation candidate hereinbelow.

The procedure component automation management function 103 reads a procedure component management DB 128, and checks whether any existing operating procedures already registered as procedure components match the process-target automation candidate (S34). That is, in Step S34, the procedure component automation management function 103 checks whether an operating procedure of a process-target automation candidate is already registered as a component.

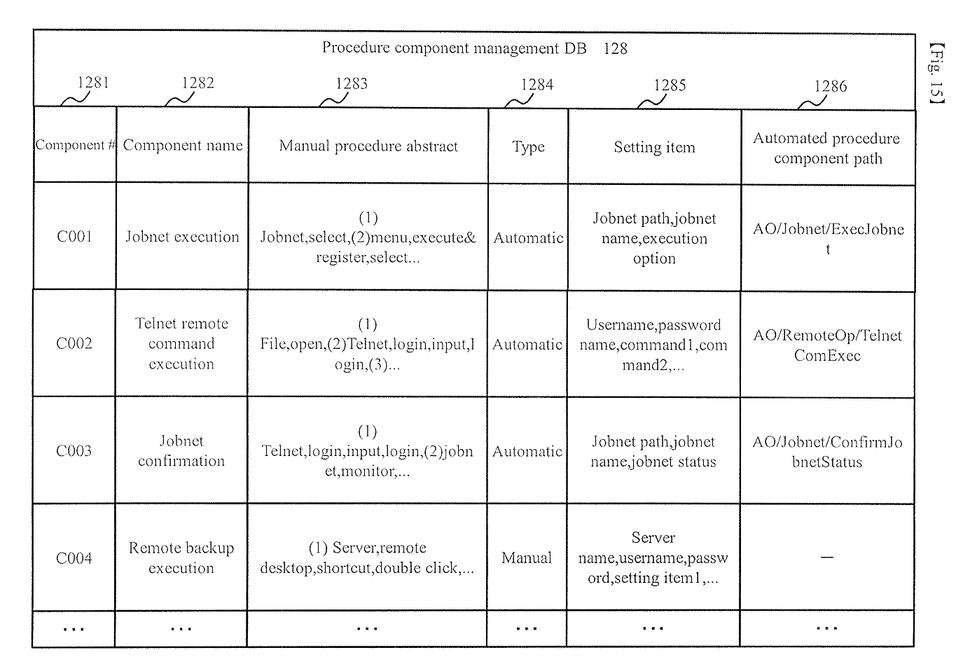

FIG. 15 shows an example of the configuration of the procedure component management DB 128. The procedure component management DB 128, for example, associatively manages a component number 1281, a component name 1282, a procedure abstract 1283, a type 1284, a setting item 1285, and an automated procedure component path 1286.

The component number 1281 is a number that identifies a procedure component. The component name 1282 is the name of a procedure component. The procedure abstract 1283 is an abstract of a case in which a procedure is performed manually. The type 1285 shows whether a procedure is capable of being executed automatically. When automatic execution is possible, “automatic” is set, and when automatic execution is not possible, “manual” is set. The setting item 1285 is an item that should be determined when introducing a procedure component. The automated procedure component path 1286 is a path for executing an automated procedure component using the operations automation function 111.

Return to FIG. 5. The procedure component automation management function 103 determines whether a registered procedure component and a process-target automation candidate match by comparing the procedure abstract 1283 of an existing procedure component (FIG. 15) to the procedure abstract 1233 of the process-target automation candidate (FIG. 10) (S35).

In the present example, an abstract 1283 of a procedure in a case of manual execution is added to the procedure component as shown in the procedure component management DB 128. However, it is not always possible to utilize a procedure abstract, for example. In a product that provides the operations automation function 111, in most cases a standard automated procedure component is used, and a procedure abstract is not added to a standard component such as this. When it is not possible to utilize a procedure abstract, a comparison as to whether an existing procedure component matches a process-target automation candidate may be done by comparing the setting items 1285 (FIG. 15).

The procedure component automation management function 103 skips Steps S36 to S38 and moves to Step S39 when an existing automated procedure component matches the process-target automation candidate procedure pattern (S35: YES). The procedure component automation management function 103 replaces the process-target automation candidate procedure pattern with the matching existing automated procedure component (S39).

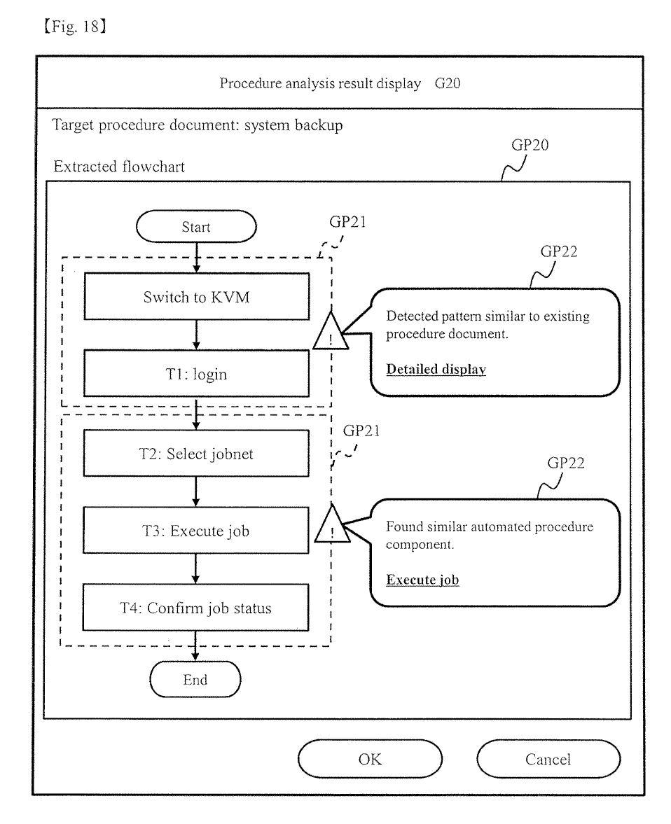

FIG. 18 shows an example of the configuration of a screen G20 for showing the operations administrator that an existing procedure component matches an analysis-target operational procedure. The screen G20, which presents a procedure analysis result, displays a flowchart extracted from the operational procedure document 215 in a flow display area GP20.

The flow display area GP20 shows an analysis result GP22 of a range GP21 of the flowchart processing extracted from the operational procedure document 215. The analysis result GP22 includes information as to whether a procedure pattern is similar to either an existing procedure document or component. When replacing a procedure pattern with an existing procedure component, the operations administrator presses an “OK” button.

Return to FIG. 5. When the process-target automation candidate does not match any existing automated procedure component (S35: NO), the procedure component automation management function 103 determines whether to prepare the process-target automation candidate as a new automated procedure component (S36). The procedure component automation management function 103 makes the determination on the basis of a button operation of the screen G10 shown in FIG. 17. When the operations administrator presses a “prepare as manual procedure component” button GP18, the procedure component automation management function 103 determines that a new automated procedure component will not be prepared (S36: NO), and ends the present processing. In this case, since the operations administrator wishes to prepare a manual procedure component, the manual procedure component management function 104 is invoked.

Alternatively, when the operations administrator presses a “prepare as automated procedure component” button GP17, the procedure component automation management function 103 determines that the process-target automation candidate is to be prepared as an automated procedure component (S36: YES).

The procedure component automation management function 103 starts the operations automation function 111, prepares a new automated procedure component, and registers this automated procedure component in the operations automation function 111 (S37).

Furthermore, as reference information for preparing the automated procedure component, the procedure numbers 1252, which are the flow of operating procedures obtained in accordance with the procedure document analysis function 101, may be exported to the operations automation function 111 as automated procedure component data 255.

After the preparation of the automated procedure component by the operations automation function 111 has ended, the procedure component automation management function 103 registers information related to the newly prepared automated procedure component in the procedure component management DB 128 (S38). Information related to the procedure pattern and the path of the automated procedure registered in the operations automation function 111 are registered in the procedure component management DB 128.

The procedure component automation management function 103, after confirming the instruction of the operations administrator, replaces the process-target automation candidate with an automated procedure component corresponding to the newly prepared automated procedure (S39). The operations administrator confirms the replacement details on the screen G20 of FIG. 18 described above, and presses the “OK” button.

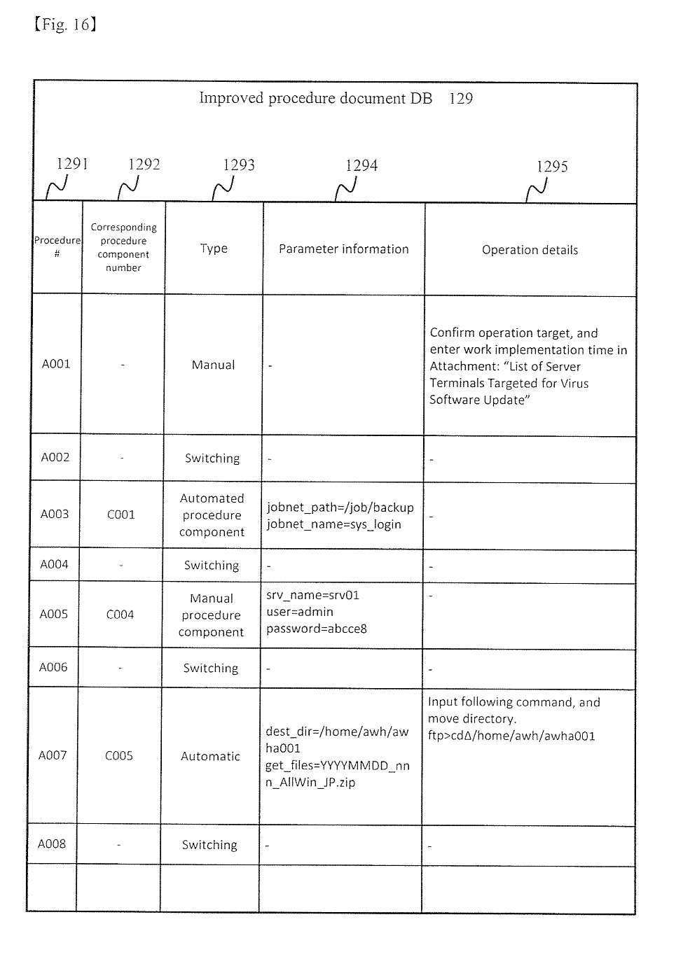

FIG. 16 shows an example of the configuration of an improved procedure document DB 129. The improved procedure document DB associatively manages a procedure number 1291, a procedure component number 1292, a type 1293, parameter information 1294, and operation details 1295.

The procedure number 1291 is created anew. The procedure component number 1292 is the number of a procedure component to be introduced. The type 1293 shows the type of procedure. As types there are a single operation performed manually, an automated procedure component, a manual procedure component, and a procedure for switching between a manual procedure and an automated procedures.

The parameter information 1294 is a parameter used when introducing a procedure component. The operation details 1295 are the details of an operation performed manually when not utilizing a procedure component. That is, the operation details 1295 show the operation details when “manual” is set in the type 1293, and a single operation is performed manually.

When an automated procedure has been introduced as a procedure component, the values of the component number 1281 and the setting item 1285 of the procedure component management DB 128 related to this procedure component are set in the corresponding procedure component number 1292 and the parameter information 1294 of the improved procedure document DB 129.

### <Manual Procedure Component Management Function>

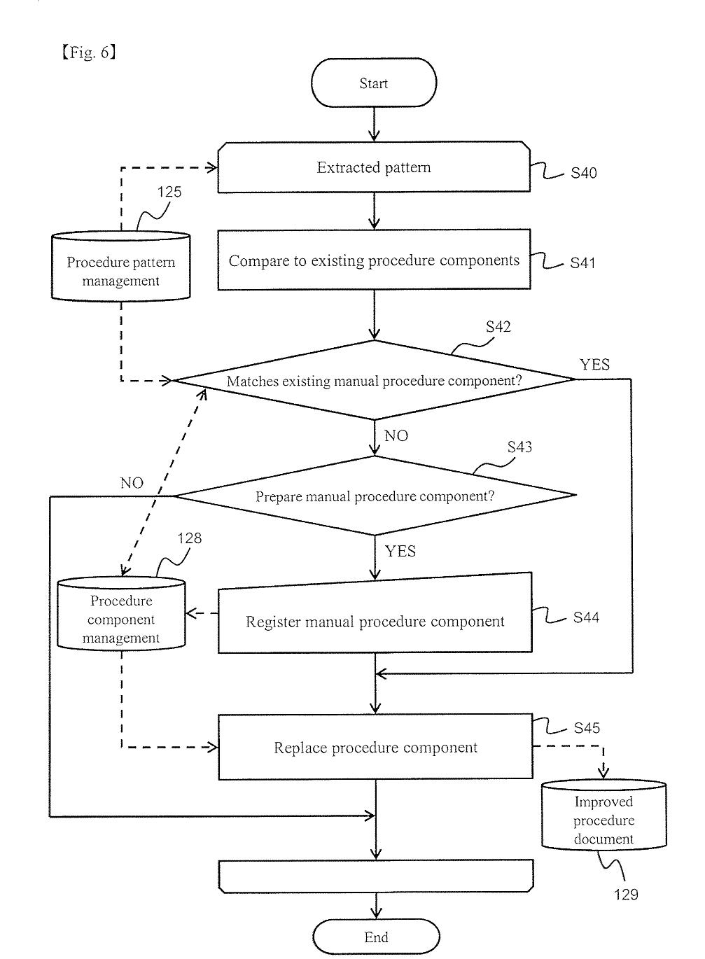

The processing of the manual procedure component management function 104 will be explained using FIG. 6. The manual procedure component management function 104 extracts a target pattern for the present processing (S40). The pattern constituting the target in the present processing is a procedure pattern that is performed manually. The manual procedure component management function 104 extracts as process-target patterns a procedure pattern for which “unautomatable” has been set in the automatability 1253 column of the procedure pattern management DB 125, and a procedure pattern for which a determination not to automate was made in Step S36 described in the processing of the procedure component automation management function 103. The following Steps S41 to S45 are executed for each extracted procedure pattern.

The manual procedure component management function 104 makes a comparison to determine whether the manual procedure component for which “manual” has been set in the type 1284 column for the procedure components registered in the procedure component management DB 128 matches the target procedure pattern (S41).

The determination as to whether a registered procedure component matches the target procedure pattern is performed by comparing the procedure abstracts 1283 of the existing procedure components to the procedure abstract 1233 and automatability 1253 of the target procedure pattern.

When an existing manual procedure component matches the target procedure pattern (S42: YES), the manual procedure component management function 104 replaces the target procedure pattern by introducing this existing manual procedure component (S45). The manual procedure component management function 104 shows that the target procedure pattern can be replaced with the existing manual procedure component via the screen G20 of FIG. 18. When the operations administrator presses the “OK” button to permit the replacement, the target manual pattern is replaced with the existing manual procedure component.

When there is no manual procedure component that matches the target procedure pattern among the existing manual procedure components (S42: NO), the manual procedure component management function 104 determines whether to prepare the target procedure pattern as a manual procedure component (S43). The determination as to whether to prepare a new manual procedure component is based on preparation instructions from the operations administrator. When the target procedure pattern is not prepared as a manual procedure component (S43: NO), the present processing ends.

When the target procedure pattern is to be prepared as a manual procedure component (S43: YES), the manual procedure component management function 104 specifies an item that should be set in the target procedure pattern when utilized as a manual procedure component. For example, a server name, a username, and so forth are set as items to be specified when utilizing this manual procedure component. The manual procedure component management function 104 registers a procedure pattern in which the item has been set as one of the procedure components (manual procedure components) in the procedure component management DB 128 (S44).

The manual procedure component management function 104 registers the procedure component by setting in the procedure component management DB 128 a new component number 1281, a procedure component name 1282, a manual procedure abstract 1283, a type 1284 showing that the procedure component is a manual procedure component, and a setting item 1285.

The manual procedure component management function 104 replaces the target procedure pattern with the newly prepared manual procedure component (S45).

The manual procedure component management function 104 outputs information regarding the procedure pattern replaced by the procedure component to the improved procedure document DB 129. The manual procedure component management function 104 respectively registers the values of the procedure component management DB 128-registered component number 1281 and setting item 1285 related to the manual procedure component that has replaced the target procedure pattern in the corresponding procedure component number 1292 and parameter information 1294 of the improved procedure document DB 129.

### <Improved Procedure Document Creation Function>

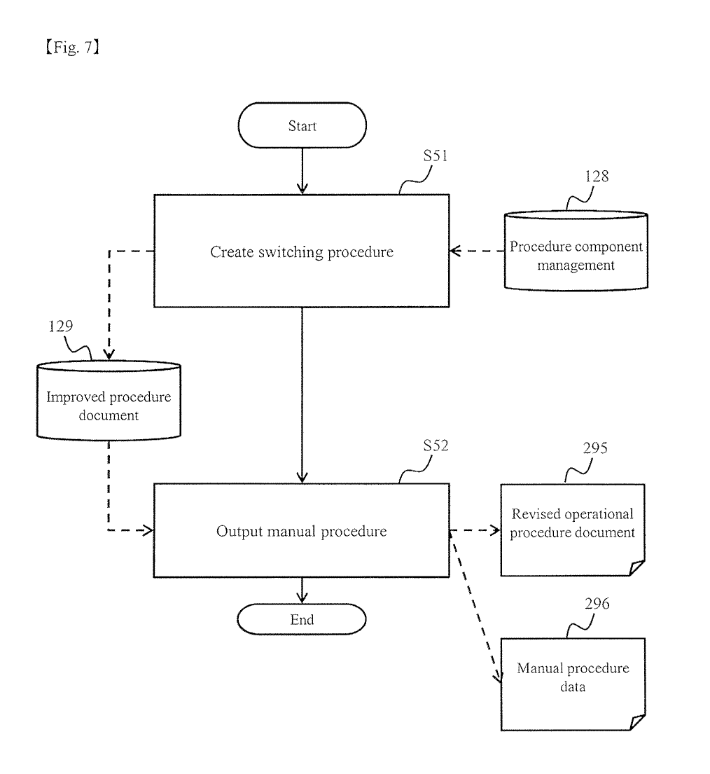

The processing of the improved procedure document creation function 105 will be explained using FIG. 7. The improved procedure document creation function 105 creates a new improved operational procedure document for the operator on the basis of operating procedure data on the procedure document analysis DB 123 created by the procedure document analysis function 101, and operating procedure data registered in the improved procedure document DB 129.

The improved operational procedures are a mixture of manual procedures executed manually by the operator, and automated procedures performed automatically using the operator terminal 140.

Accordingly, the improved procedure document creation function 105 creates a procedure (hereinafter, switching procedure) for supporting the switching of manual procedures and automated procedures (S51). The switching procedure is created so as to execute an automated procedure after a manual procedure has ended, and is added to a manual procedure (S52).

The switching procedure reads the automated execution path 1286 for starting an automated procedure component and the parameter information 1294 regarding a setting item, and creates a command for starting the operations automation function 111. This start command starts the operations automation function 111 by delivering the automated execution path and parameter information to the operations automation function 111.

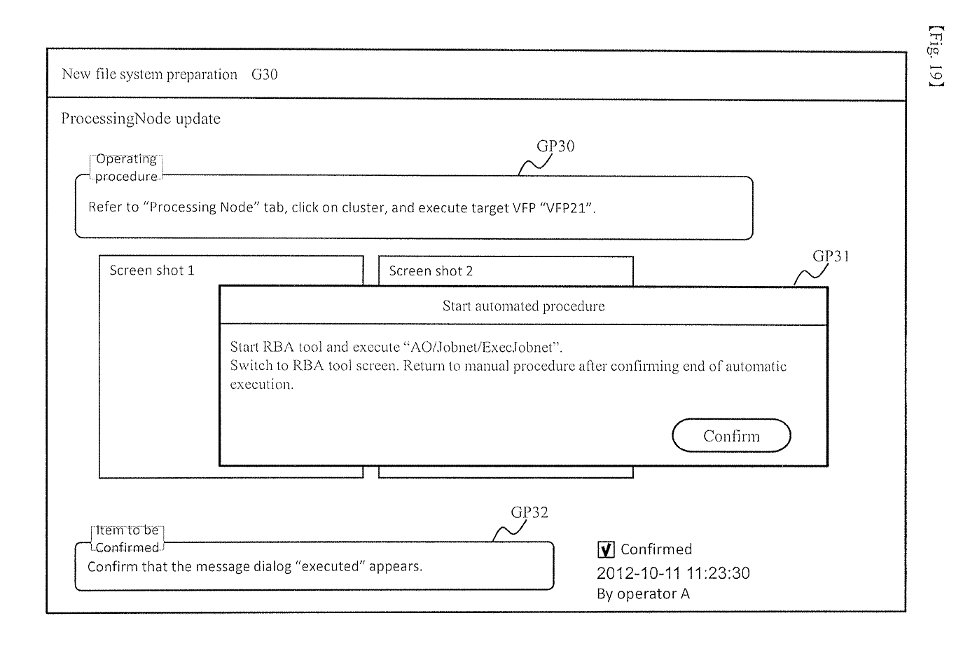

FIG. 19 shows an example of the configuration of a screen in a case where an automated procedure is to be executed after a manual procedures has ended. In this screen G30, for example, a new file system is prepared by executing a manual procedure and an automated procedure in an alternating manner, i.e., manual procedure, automated procedure, manual procedure.

The screen G30 includes an area GP30 for displaying a manual procedure, and area GP31 for notifying the start of an automated procedure, and an area GP32 for displaying a confirmation item for when the processing returns to the manual procedure after the automated procedure has ended.

As shown in area GP31, an automated execution path for starting an automated procedure that is to be executed next is included at the end of the manual procedure, and the automated procedure is started after waiting for confirmation from the operator (or the operations administrator).

After the automated procedure has ended, a confirmation screen for automatic execution on the operations automation function 111 is invoked, and the result of automated procedure execution is presented to the operator. After obtaining confirmation from the operator, the processing moves to the screen of the manual procedure that is to be executed next.

In accordance with the above, it is possible to create an improved operational procedure that includes an automated operating procedure. The improved operational procedure may be outputted as a hard copy of an operational procedure document 295, or may be outputted as manual procedure data 296 that corresponds to the manual procedure execution support function 112.

According to the present example, which is configured in this manner, it is possible to improve the operations management and enhance the usability of an information processing system.

In the present example, an operational procedure document is analyzed, the costs required for a procedure to be executed manually are calculated in a comprehensive manner from a plurality of different perspectives, and a candidate that should be converted to an automated procedure component is presented on the basis of the calculated costs. Therefore, the operations administrator can easily confirm a procedure for which automation would prove very effective, and can instruct the automation thereof.

In the present example, the cost required for an operation is calculated in a comprehensive manner from the plurality of perspectives of a cost derived from the number of procedures per operation performed manually by the operator, a cost derived from the waiting time until an operation result appears, and a cost derived from a human operational error. Therefore, a procedure for which automation would prove very effective can be extracted from among a plurality of operational procedures on the basis of information processing system conditions and operator proficiency.

In the present example, an overview (procedure abstract) of procedures in an operational procedure document is prepared, and the repetition of the same or similar procedures is detected by comparing the procedure abstracts. A procedure abstract is prepared by extracting important keywords related to operations management that are included in the procedure. Therefore, it is possible to efficiently detect the occurrence of repetitions by extracting procedures that have substantially the same details but are simply described differently in the operational procedure document.

In addition, in the present example, since the product obtained by multiplying the above-described costs and number of repetitions is presented to the operations administrator, the operations administrator is able to find procedures that would be even more effective when automated, thereby enhancing the user friendliness of operations management.

Furthermore, the above-described example has been explained in detail to make the present invention easier to understand, but the present invention is not necessarily limited to an apparatus that comprises all of the configurations that were explained. In addition, the configurations disclosed in the claims can be combined in various ways other than the stated combinations.

### REFERENCE SIGNS LIST

100 Operations analysis server
110 Operations management server
120 Storage
140 Operator terminal
145 Operations management terminal
146 Management-target device

1. An apparatus for improving operations that improves the operations of an information processing system, the apparatus comprising:
a computing apparatus; and
a storage apparatus that is used by the computing apparatus, wherein
the computing apparatus, by executing a prescribed computer program,
acquires operational procedure information that includes a plurality of operational procedures of the information processing system,
extracts a procedure automation candidate, which is a candidate for a procedure that is capable of being automated, by analyzing the acquired operational procedure information; and
outputs the extracted procedure automation candidate.

2. The apparatus for improving operations of an information processing system according to claim 1, wherein, by analyzing the acquired operational procedure information, the computing apparatus extracts the procedure automation candidate on the basis of an operation cost related to performing an operational procedure.

3. The apparatus for improving operations of an information processing system according to claim 2, wherein
the storage apparatus stores a cost definition table beforehand,
the cost definition table is created by associating a prescribed cost that constitutes the basis of the operation cost calculation with each prescribed word related to the operational procedure, and
the computing apparatus extracts the procedure automation candidate on the basis of the operation cost by using the cost definition table to perform text analysis on the acquired operational procedure information.

4. The apparatus for improving operations of an information processing system according to claim 3, wherein the computing apparatus performs a display output of the extracted procedure automation candidates in descending order of the operation costs.

5. The apparatus for improving operations of an information processing system according to claim 4, wherein the prescribed cost includes a standard cost that is set as a standard required time in a case where an operator performs the operational procedure manually.

6. The apparatus for improving operations of an information processing system according to claim 5, wherein the prescribed cost further includes a waiting cost that is set as a waiting time required to obtain a processing result from the information processing system when an operator performs the operational procedure manually.

7. The apparatus for improving operations of an information processing system according to claim 6, wherein the prescribed cost further includes a risk cost that is set as the risk of an operational error occurring when an operator performs the operational procedure manually.

8. The apparatus for improving operations of an information processing system according to claim 7, wherein the computing apparatus creates an automated procedure component, which is a software component for automatically executing a procedure automation candidate selected from among the outputted procedure automation candidates.

9. The apparatus for improving operations of an information processing system according to claim 8, wherein, when executing the automated procedure component after a manual procedure is performed by an operator from among the operational procedures, the computing apparatus adds to the manual procedure a switching procedure for starting the automated procedure component.

10. The apparatus for improving operations of an information processing system according to claim 3, wherein the computing apparatus, in accordance with using the cost definition table to perform text analysis on the acquired operational procedure information, extracts a procedure automation candidate pattern that includes a plurality of the procedure automation candidates, and outputs the extracted procedure automation candidate pattern.

11. A method of improving operations that improves operations of an information processing system using a computer,
the method comprising operating the computer:
to acquire operational procedure information including a plurality of operational procedures of the information processing system;
to extract, in accordance with analyzing the acquired operational procedure information, a procedure automation candidate, which is a candidate for a procedure that is capable of being automated, on the basis of an operation cost related to the implementation of an operational procedure; and
to output the extracted procedure automation candidate.

12. The method of improving operations of an information processing system according to claim 11, wherein
the computer stores a cost definition table beforehand,
the cost definition table is created by associating a prescribed cost that constitutes the basis of the operation cost calculation with each prescribed word related to the operational procedure, and
the computer extracts the procedure automation candidate by using the cost definition table to perform text analysis on the acquired operational procedure information.

13. The method of improving operations of an information processing system according to claim 12, wherein the prescribed cost includes either one or both of a standard cost that is set as a standard required time in a case where an operator performs the operational procedure manually, or one or both of a waiting cost that is set as a waiting time required to obtain a processing result from the information processing system when an operator performs the operational procedure manually, or a risk cost that is set as the risk of an operational error occurring when an operator performs the operational procedure manually.

14. The method of improving operations of an information processing system according to claim 13, wherein the computer creates an automated procedure component, which is a software component for automatically executing a procedure automation candidate selected from among the outputted procedure automation candidates.

15. The method of improving operations of an information processing system according to claim 14, wherein the computer, when executing the automated procedure component after a manual procedure performed by an operator from among the operational procedures, adds a switching procedure for starting the automated procedure component to the manual procedure.
